(19) United States
(12) Patent Application Publication
(10) Pub. No.: US 2015/0318573 A1
(43) Pub. Date: Nov. 5, 2015

(54) ELECTROLYTE FOR LITHIUM SECONDARY BATTERY, AND LITHIUM SECONDARY BATTERY COMPRISING SAME

(71) Applicant: SK INNOVATION CO., LTD., Jongno-gu Seoul (KR)

(72) Inventors: Jin Sung KIM, Daejeon (KR); Seong Il LEE, Daejeon (KR); Jong Ho LIM, Daejeon (KR); Jin Su HAM, Daejeon (KR)

(21) Appl. No.: 14/650,202

(22) PCT Filed: Dec. 5, 2013
(86) PCT No.: PCT/KR2013/011240

§ 371 Date: Jun. 5, 2015

(30) Foreign Application Priority Data
Dec. 5, 2012 (KR) 10-2012-0140427

(51) Int. Cl. H01M 10/0568; H01M 10/0567; H01M 10/0569; H01M 10/052

(52) U.S. Cl. CPC H01M 10/0568; H01M 10/052; H01M 10/0567; H01M 10/0569; H01M 2300/0025; H01M 2300/0037

(57) ABSTRACT

Provided are an electrolyte for a lithium secondary battery which is not oxidized/decomposed when allowed to stand at a high temperature under high voltage, so as to inhibit generation of gas to prevent expansion of the battery, thereby reducing a battery thickness increase rate, and simultaneously having an excellent storage property at a high temperature, and a lithium secondary battery including the same.

### TECHNICAL FIELD

The present invention relates to an electrolyte for a lithium secondary battery and a lithium secondary battery including the same, and more particularly, to an electrolyte for a lithium secondary battery which is not oxidized/decomposed when allowed to stand at a high temperature under high voltage, so as to inhibit generation of gas to prevent expansion of the battery, thereby reducing a battery thickness increase rate, and while simultaneously has an excellent storage property at a high temperature, and a lithium secondary battery including the same.

### BACKGROUND ART

Recently, portable electronic devices have been widely spread, and accordingly, for a battery as a power supply for such portable electronic devices which is progressing to become smaller, lighter and thinner, development of a secondary battery being compact and lightweight, capable of being charged and discharged over a long time, and having an excellent high rate property is strongly demanded.

Among currently applied secondary batteries, a lithium secondary battery developed in early 1990s, has been spotlighted, due to the advantages of high operating voltage and much higher energy density as compared with conventional batteries such as NiMH, NiCd and lead sulfate batteries using an aqueous electrolyte. However, such lithium secondary battery has a safety problem such as ignition and explosion due to use of a non-aqueous electrolyte, and such problem becomes more serious as the capacity density of a battery is increased.

Safety of a battery is lowered when continuously charged, which is very problematic in a non-aqueous electrolyte secondary battery. One of the reasons affecting this is heat generation due to structural collapse of a cathode. The working principle is as follows: that is, a cathode active material of a non-aqueous electrolyte battery consists of a lithium containing metal oxide capable of absorbing and releasing lithium and/or lithium ions and the like, and when such cathode active material is overcharged, a large amount of lithium is released, and thus, it is deformed so as to have a thermally unstable structure. When a battery temperature reaches a critical temperature due to external physical shocks, for example, high temperature exposure and the like in such an overcharged state, oxygen is released from a cathode active material having an unstable structure, and the released oxygen undergoes an exothermic decomposition reaction with an electrolyte solvent and the like. Particularly, since combustion of an electrolyte is accelerated by oxygen released from a cathode, ignition and rupture of a battery due to thermal runaway is caused by an exothermic chain reaction.

In order to control ignition or explosion due to temperature increase within a battery as described above, a method of adding an aromatic compound to an electrolyte as a redox shuttle additive is used. For example, Japanese Patent Publication No. 2002260725 discloses a non-aqueous lithium ion battery capable of preventing overcharging current and thermal runaway resulted therefrom, using an aromatic compound such as biphenyl. Further, U.S. Pat. No. 5,879,834 discloses a method of improving battery safety by adding a small amount of an aromatic compound such as biphenyl and 3-chlorothiophene to allow to be electrochemically polymerized during an abnormal overvoltage state, thereby increasing internal resistance.

However, in case of using an additive such as biphenyl, there is a problem in that under general operating voltage, when relatively high voltage is locally generated, the additive is gradually decomposed during a charge-discharge process, or when a battery is discharged at a high temperature over a long period of time, an amount of biphenyl and the like is gradually decreased, and after 300 cycles of charge-discharge, safety is not guaranteed, and also, there is a problem of a storage property.

Meanwhile, in order to increase electric charge for compactness and larger capacity of a battery, a high voltage battery (4.4V system) has been continuously researched and developed. Increased charge voltage generally increases a charge amount under the same battery system. However, there may be generated safety problems such as electrolyte decomposition, lack of a lithium absorption space, and a risk from potential rise of an electrode. Therefore, in order to manufacture a battery operated at high voltage, overall conditions are managed by a system, so that a larger standard reduction potential difference between an anode active material and a cathode active material is easily maintained, and an electrolyte is not decomposed at this voltage level.

Considering such features of a high voltage battery, it may be easily recognized that in case of using the existing overcharge inhibitors such as biphenyl (BP) or cyclohexylbenzene (CHB) used in a general lithium ion battery, they are much more decomposed even during a normal charge-discharge operation, and the characteristics of the battery are rapidly deteriorated even at a slightly higher temperature, thereby shortening a battery life. Further, in case of using a non-aqueous carbonate based solvent which is generally used in the art as an electrolyte, if a battery is charged to a voltage higher than 4.2V which is a typical charging potential, its oxidizing power is increased, and thus, as a charge discharge cycle proceeds, a decomposition reaction of an electrolyte proceeds, thereby rapidly deteriorating a life characteristic.

Accordingly, development of a method for improving stability and capacity during high temperature safety without reducing a life characteristic of a high voltage battery (4.4V system) has been consistently demanded.

### DISCLOSURE

### Technical Problem

An object of the present invention is to provide an electrolyte for a high voltage lithium secondary battery maintaining good basic performances such as a high rate charge and discharge property and a life characteristic, while remarkably improving swelling of a battery due to oxidation/decomposition of an electrolyte in a high voltage state, thereby having an excellent storage property at a high temperature, and a high voltage lithium secondary battery including the same.

### Technical Solution

In one general aspect, an electrolyte for a lithium secondary battery includes:

a lithium salt;

a non-aqueous organic solvent; and an ester compound represented by following Chemical Formula 1:

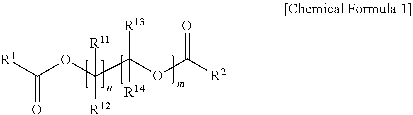

wherein

R¹ and R² are independently of each other a (C1-C5) alkyl group or a (C1-C5) alkoxy group;

R¹¹ to R¹⁴ are independently of one another hydrogen, a (C1-C5) alkyl group, a (C1-C5) alkoxy group or

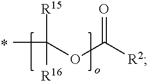

R¹⁵ and R¹⁶ are independently of each other hydrogen, a (C1-C5) alkyl group or a (C1-C5) alkoxy group; R³ is a (C1-C5) alkyl group or a (C1-C5) alkoxy group; o is an integer of 0 to 3;

m is an integer of 0 to 6;

n is an integer of 0 to 6; and m and n are not 0 at the same time.

In the electrolyte for a lithium secondary battery according to an exemplary embodiment of the present invention, in above Chemical Formula 1, R¹¹ to R¹⁴ are independently of each other hydrogen or

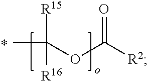

R¹⁵ and R¹⁶ are independently of each other hydrogen, a (C1-C5) alkyl group or a (C1-C5) alkoxy group; and o is an integer of 0 to 3; and more particularly, in above Chemical Formula 1, R¹¹ to R¹⁴ are independently of each other hydrogen or

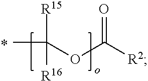

R¹⁵ and R¹⁶ are independently of each other hydrogen, a (C1-C5) alkyl group or a (C1-C5) alkoxy group; o is an integer of 0 to 3; and R¹ and R² are independently of each other methyl, ethyl, propyl, isopropyl, n-butyl, tert-butyl, methoxy, ethoxy, propoxy, n-butoxy or tert-butoxy.

In the electrolyte for a lithium secondary battery according to an exemplary embodiment of the present invention, the above Chemical Formula 1 may be selected from the group consisting of the following structures, but not limited thereto:

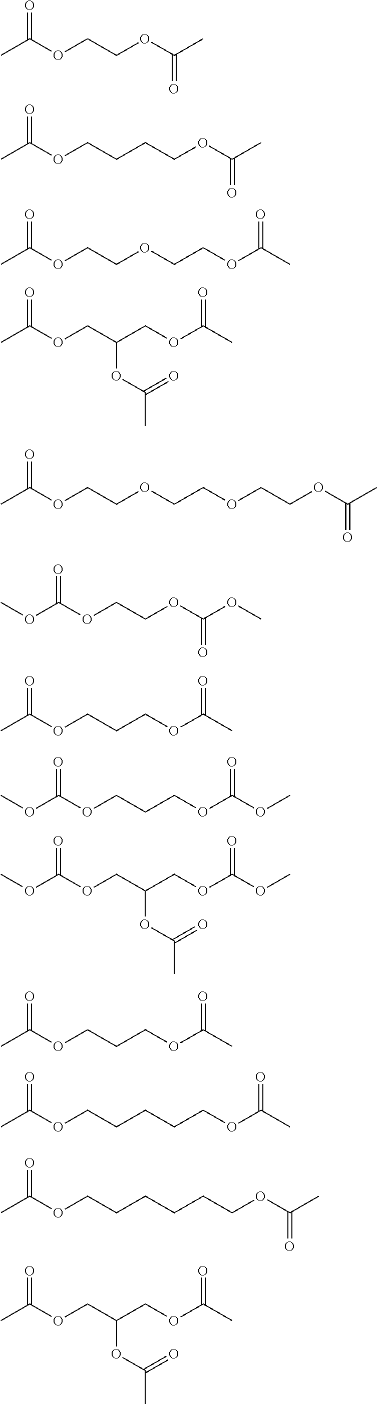

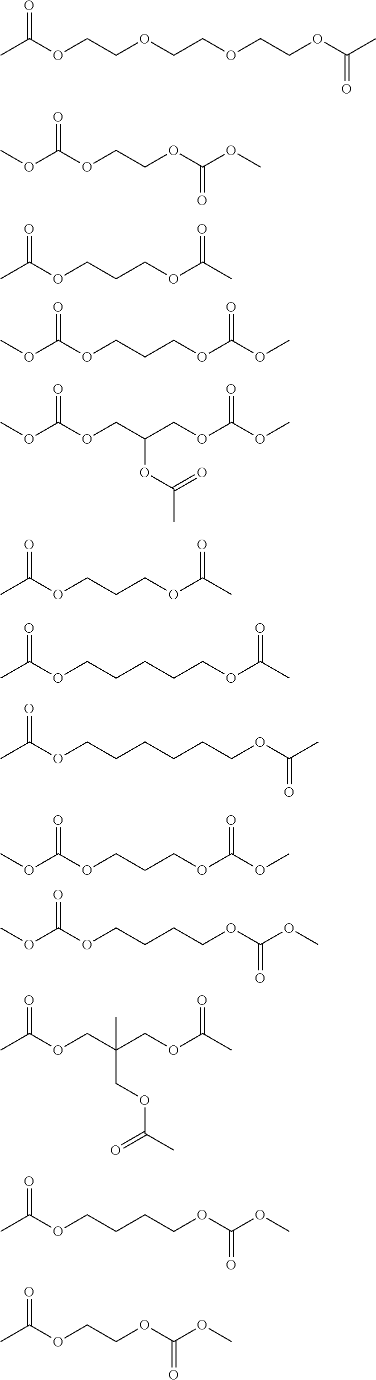

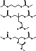

In the electrolyte for a lithium secondary battery according to an exemplary embodiment of the present invention, the ester compound represented by the above Chemical Formula 1 may be contained in 1 to 20 wt %, based on a total weight of the electrolyte.

In the electrolyte for a lithium secondary battery according to an exemplary embodiment of the present invention, the electrolyte may further include one or two or more additives selected from the group consisting of an oxalatoborate-based compound, a fluorine-substituted carbonate-based compound, a vinylidene carbonate-based compound, and a sulfinyl group-containing compound.

In the electrolyte for a lithium secondary battery according to an exemplary embodiment of the present invention, the electrolyte may further include an additive selected from the group consisting of lithium difluorooxalatoborate (LiFOB), lithium bisoxalatoborate (LiB(C₂O₄)₂, LiBOB), fluoroethylenecarbonate (FEC), vinylene carbonate (VC), vinylethylene carbonate (VEC), divinyl sulfone, ethylene sulfite, propylene sulfite, diallyl sulfonate, ethane sultone, propane sultone (PS), butane sultone, ethene sultone, butene sultone and propene sultone (PRS).

In the electrolyte for a lithium secondary battery according to an exemplary embodiment of the present invention, the additive may be contained in 0.1 to 5.0 wt %, based on a total weight of the electrolyte.

In the electrolyte for a lithium secondary battery according to an exemplary embodiment of the present invention, the non-aqueous organic solvent may be selected from the group consisting of a cyclic carbonate-based solvent, a linear carbonate-based solvent and a mixed solvent thereof; the cyclic carbonate may be selected from the group consisting of ethylene carbonate, propylene carbonate, butylene carbonate, vinylene carbonate, vinylethylene carbonate, fluoroethylene carbonate and a mixture thereof; and the linear carbonate may be selected from the group consisting of dimethyl carbonate, diethyl carbonate, dipropyl carbonate, ethylmethyl carbonate, methylpropyl carbonate, methylisopropyl carbonate, ethylpropyl carbonate and a mixture thereof.

In the electrolyte for a lithium secondary battery according to an exemplary embodiment of the present invention, the non-aqueous organic solvent may have a mixed volume ratio between the linear carbonate solvent: the cyclic carbonate solvent of 1:1 to 9:1.

In the electrolyte for a lithium secondary battery according to an exemplary embodiment of the present invention, the lithium salt may be one or two or more selected from the group consisting of LiPF₆, LiBF₄, LiClO₄, LiSbF₆, LiAsF₆, LiN(SO₂C₂F₅)₂, LiN(CF₃SO₂)₂, LiN(SO₃C₂F₅)₂, LiCF₃SO₃, LiC₄F₉SO₃, LiC₄H₅SO₃, LiSCN, LiAlO₂, LiAlCl₄, LiN(CₓF₂ₓ₊₁SO₂) (C_{y}F_{2y+1}SO₂) (wherein x and y are a natural number), LiCl, LiI, and LiB(C₂O₄)₂.

In the electrolyte for a lithium secondary battery according to an exemplary embodiment of the present invention, the lithium salt may be present at a concentration of 0.1 to 2.0 M.

In another general aspect, a lithium secondary battery includes the electrolyte for a lithium secondary battery.

### Advantageous Effects

The electrolyte for a lithium secondary battery according to the present invention includes a compound having two or more ester groups or carbonate groups in the compound, thereby remarkably improving swelling of a battery due to oxidation/decomposition of an electrolyte in a high voltage state, so as to show an excellent storage property at a high temperature.

Accordingly, the lithium secondary battery including the electrolyte for a lithium secondary battery according to the present invention maintains good basic performances such as a charge and discharge property with a high efficiency and a life characteristic, while remarkably improving swelling of a battery due to oxidation/decomposition of an electrolyte in a high voltage state, so as to show an excellent storage property at a high temperature to have high storage stability.

### DESCRIPTION OF DRAWINGS

The above and other objects, features and advantages of the present invention will become apparent from the following description of preferred embodiments given in conjunction with the accompanying drawings, in which:

FIG. 1 is a graph representing results of oxidative decomposition voltage measurements according to Examples 1 to 3, and Comparative Examples 2 and 3, and

FIG. 2 is a graph representing results of oxidative decomposition voltage measurements according to Examples 4 to 6, and Comparative Examples 2 and 3.

### BEST MODE

Hereinafter, the embodiments of the present invention will be described in detail with reference to accompanying drawings. Technical terms and scientific terms used in the present specification have the general meaning understood by those skilled in the art to which the present invention pertains unless otherwise defined, and a description for the known function and configuration unnecessarily obscuring the gist of the present invention will be omitted in the following description.

The present invention relates to an electrolyte for a lithium secondary battery for providing a battery securing stability of a battery in a high voltage state, and also having excellent storage property at a high temperature and life characteristic.

The present invention provides an electrolyte for a lithium secondary battery including a lithium salt; a non-aqueous organic solvent; and an ester compound represented by following Chemical Formula 1:

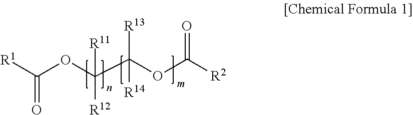

wherein

R¹ and R² are independently of each other a (C1-C5) alkyl group or a (C1-C5) alkoxy group;

R¹¹ to R¹⁴ are independently of one another hydrogen, a (C1-C5) alkyl group, a (C1-C5) alkoxy group or

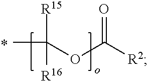

R¹⁵ and R¹⁶ are independently of each other hydrogen, a (C1-C5) alkyl group or a (C1-C5) alkoxy group;

o is an integer of 0 to 3;

m is an integer of 0 to 6;

n is an integer of 0 to 6; and m and n are not 0 at the same time.

The electrolyte for a secondary battery of the present invention includes an ester compound represented by the above Chemical Formula 1 of a predetermined structure having independently of each other two or more ester groups or carbonate groups in the compound, thereby inhibiting a side reaction in a battery, which causes swelling of a battery due to oxidation/decomposition of an electrolyte in a high voltage state to be remarkably improved, so as to show an excellent storage property at a high temperature.

In the electrolyte for a lithium secondary battery according to an exemplary embodiment of the present invention, in the above Chemical Formula 1, R¹¹ to R¹⁴ are independently of one another hydrogen or

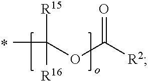

R¹⁵ and R¹⁶ are independently of each other hydrogen, a (C1-C5) alkyl group or a (C1-C5) alkoxy group; o is an integer of 0 to 3; R¹ and R² are independently of each other methyl, ethyl, propyl, isopropyl, n-butyl, tert-butyl, methoxy, ethoxy, propoxy, n-butoxy or tert-butoxy.

More particularly, the Chemical Formula 1 may be selected from the group consisting of the following structures, but not limited thereto:

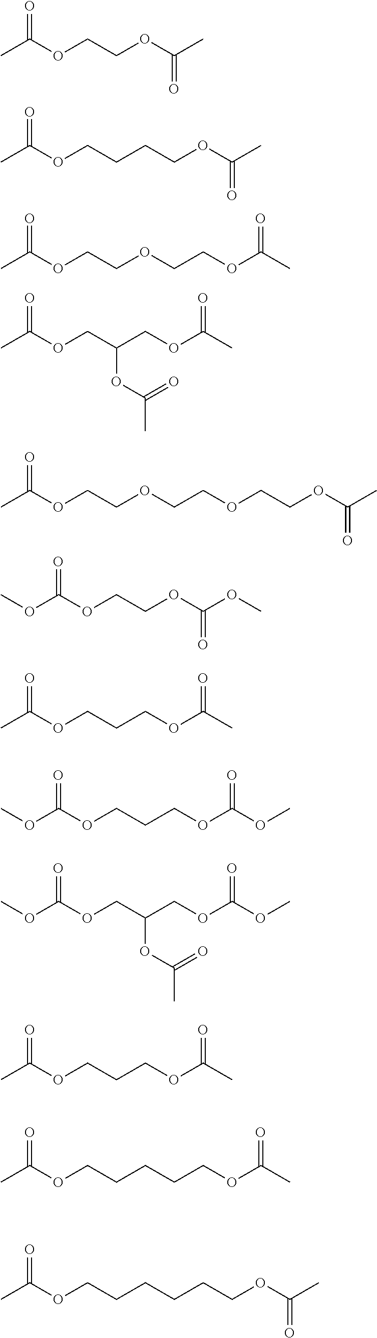

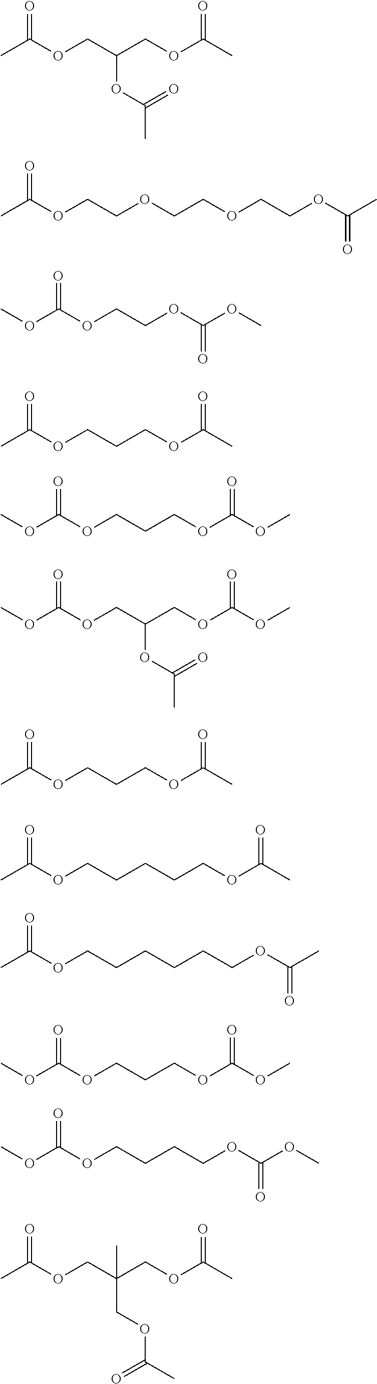

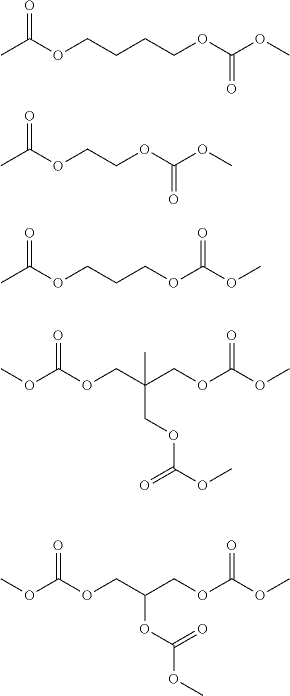

In the electrolyte for a lithium secondary battery according to an exemplary embodiment of the present invention, the ester compound of the Chemical Formula 1 may be contained in 1 to 20 wt %, and more preferably 1 to 15 wt %, based on a total weight of the electrolyte for a secondary battery. If the content of the ester compound of the Chemical Formula 1 is less than 1 wt %, an addition effect is not shown, for example, swelling of a battery during high temperature storage is not inhibited, or improvement of a capacity retention rate is insignificant, and an effect of improving discharge capacity, output or the like of a lithium secondary battery is insignificant; and if the content of the ester compound of the Chemical Formula 1 is above 20 wt %, characteristics of a lithium secondary battery are rather lowered, for example, rapid deterioration of battery life occurs.

In the electrolyte for a lithium secondary battery according to an exemplary embodiment of the present invention, the electrolyte may further include one or two or more additives selected from the group consisting of an oxalatoborate-based compound, a fluorine-substituted carbonate-based compound, a vinylidene carbonate-based compound, and a sulfinyl group-containing compound, as a life improving additive for improving battery life.

The oxalatoborate-based compound may be a compound represented by following Chemical Formula 2 or lithium bisoxalatoborate (LiB(C₂O₄)₂, LiBOB):

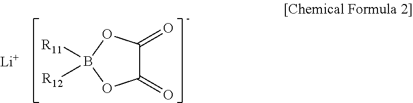

wherein R₁₁ and R₁₂ are independently of each other a halogen element or a halogenated C1 to C10 alkyl group.

A specific example of the oxalatoborate-based additive includes LiB(C₂O₄)F₂ (lithiumdifluoro oxalatoborate, LiFOB), LiB(C₂O₄)₂ (lithiumbisoxalatoborate, LiBOB) or the like.

The fluorine-substituted carbonate-based compound may be fluoroethylene carbonate (FEC), difluoroethylene carbonate (DFEC), fluorodimethyl carbonate (FDMC), fluoroethylmethyl carbonate (FEMC), or a combination thereof.

The vinylidene carbonate-based compound may be vinylene carbonate (VC), vinyl ethylene carbonate (VEC) or a mixture thereof.

The sulfinyl group (S═O) containing compound may be sulfone, sulfite, sulfonate or sultone (cyclic sulfonate), and these may be used alone or in combination. Specifically, the sulfone may be represented by following Chemical Formula 3, and may be divinyl sulfone. The sulfite may be represented by following Chemical Formula 4, and may be ethylene sulfite or propylene sulfite. The sulfonate may be represented by following Chemical Formula 5, and may be diallyl sulfonate. Further, non-limited examples of the sultone may include ethane sultone, propane sultone, butane sultone, ethene sultone, butene sultone, propene sultone and the like.

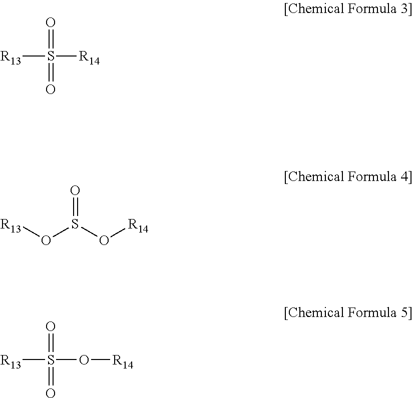

wherein R₁₃ and R₁₄ are independently of each other hydrogen, a halogen atom, a C1-C10 alkyl group, a C2-C10 alkenyl group, a halogen-substituted C1C10 alkyl group or a halogen-substituted C2-C10 alkenyl group.

In the electrolyte for a high voltage lithium secondary battery according to an exemplary embodiment of the present invention, more preferably the electrolyte may further include an additive selected from the group consisting of lithium difluorooxalatoborate (LiFOB), lithium bisoxalatoborate (LiB(C₂O₄)₂, LiBOB), fluoroethylene carbonate (FEC), vinylene carbonate (VC), vinylethylene carbonate (VEC), divinyl sulfone, ethylene sulfite, propylene sulfite, diallyl sulfonate, ethane sultone, propane sultone (PS), butane sultone, ethene sultone, butene sultone and propene sultone (PRS).

In the electrolyte for a lithium secondary battery according to an exemplary embodiment of the present invention, the content of the additive is not significantly limited, but in order to improve battery life in a secondary battery electrolyte, the additive may be contained in 0.1 to S wt %, more preferably 0.1 to 3 wt %, based on a total weight of the electrolyte.

In the electrolyte for a lithium secondary battery according to an exemplary embodiment of the present invention, the non-aqueous organic solvent may include carbonate, ester, ether or ketone alone or in combination, but it is preferred that the non-aqueous organic solvent is selected from the group consisting of a cyclic carbonate-based solvent, a linear carbonate-based solvent and a mixed solvent thereof, and it is most preferred to use a mixture of a cyclic carbonate-based solvent and a linear carbonate based solvent. The cyclic carbonate solvent has so high polarity that it may sufficiently dissociate lithium ions, but since it has high viscosity, its ion conductivity is low. Therefore, the cyclic carbonate solvent may be mixed with a linear carbonate solvent having low polarity, but also having low viscosity, thereby optimizing the characteristics of a lithium secondary battery.

The cyclic carbonate-based solvent may be selected from the group consisting of ethylene carbonate, propylene carbonate, butylene carbonate, vinylene carbonate, vinylethylene carbonate, fluoroethylene carbonate and a mixture thereof, and the linear carbonate-based solvent may be selected from the group consisting of dimethyl carbonate, diethyl carbonate, dipropyl carbonate, ethylmethyl carbonate, methylpropyl carbonate, methylisopropyl carbonate, ethylpropyl carbonate and a mixture thereof.

In the electrolyte for a lithium secondary battery according to an exemplary embodiment of the present invention, the non-aqueous organic solvent which is a mixed solvent of a cyclic carbonate-based solvent and a linear carbonate-based solvent, may be used with a mixed volume ratio between the linear carbonate solvent: the cyclic carbonate solvent of 1:1 to 9:1, preferably 1.5:1 to 4:1.

In the electrolyte for a high voltage lithium secondary battery according to an exemplary embodiment of the present invention, the lithium salt may be one or two or more selected from the group consisting of LiPF₆, LiBF₄, LiClO₄, LiSbF₆, LiAsF₆, LiN(SO₂C₂F₅)₂, LiN(CF₄SO₂)₂, LiN(SO₃C₂F₅)₂, LiCF₃SO₃, LiC₄F₉SO₃, Li₆H₅SO₃, LiSCN, LiAlO₂, LiAlCl₄, LiN(CₓF₂ₓ₊₁SO₂) (C_{y}F_{2y+1}SO₂) (wherein x and y are a natural number), LiCl, LiI, and LiB(C₂O₄)₂, but not limited thereto.

The concentration of the lithium salt is preferably within a range of 0.1 to 2.0 M, and more preferably within a range of 0.7 to 1.6 M. If the concentration of the lithium salt is less than 0.1 M, the conductivity of the electrolyte is lowered such that the performance of the electrolyte becomes poor, and if the concentration of the lithium salt is above 2.0 M, the viscosity of the electrolyte is increased such that the mobility of lithium ions becomes reduced. The lithium salt acts as a source of lithium ions in a battery, thereby allowing a basic operation of a lithium secondary battery.

The electrolyte for a high voltage lithium secondary battery of the present invention is generally stable at a temperature in a general range of 20-60° C. and maintains an electrochemically stable property even at a voltage in a range of 4.4V, and thus, the electrolyte may be applied to all kinds of lithium secondary batteries such as a lithium ion battery and a lithium polymer battery.

Further, the present invention provides a lithium secondary battery including the electrolyte for a lithium secondary battery.

A non-limited example of the secondary battery includes a lithium metal secondary battery, a lithium ion secondary battery, a lithium polymer secondary battery, a lithium ion polymer secondary battery, or the like.

The lithium secondary battery manufactured from the electrolyte for a lithium secondary battery according to the present invention is characterized by showing a storage efficiency at a high temperature of 80% or more, and at the same time, having a very low battery thickness increase rate of only 1-15% when allowed to stand at a high temperature over a long period of time.

The lithium secondary battery of the present invention includes a cathode and an anode.

The cathode includes a cathode active material capable of absorbing and releasing lithium ions, and the cathode active material is preferably at least one selected from the group consisting of cobalt, manganese and nickel, and a composite metal oxide with lithium. An employment ratio between metals may be various, and in addition to these metals, an element selected from the group consisting of Mg, Al, Co, K, Na, Ca, Si, Ti, Sn, V, Ge, Ga, B, As, Zr, Mn, Cr, Fe, Sr, V and rare earth elements may be further included. As a specific example of the cathode active material, a compound represented by any one of following Chemical Formulae may be used:

LiₐA_{1b}B_{b}D₂ (wherein 0.90≦a≦1.8, and 0≦b≦0.5); LiₐE_{1b}B_{b}O_{2c}D_{c} (wherein 0.90≦a≦1.3, 0≦0.5, and 0≦c≦0.05); LiE_{2b}B_{b}O_{4c}D_{c} (wherein 0≦b≦0.5, and 0≦c≦0.05); LiₐNi_{1bc}CO_{b}B_{c}D_{c} (wherein 0.90≦a≦1.8, 0≦b≦0.5, 0≦c≦0.05, and 0≦α≦2); LiₐNi_{1bc}Co_{b}B_{c}O₂ₐFₐ (wherein 0.90≦a≦1.8, 0≦b≦0.5, 0≦c≦0.05, and 0≦a≦2); LiₐNi_{1bc}Co_{b}B_{c}O₂ₐF₂ (wherein 0.90≦a≦1.8, 0≦0.5, 0≦c≦0.05, and 0<α<2); LiₐNi_{1bc}Mn_{b}B_{c}D_{α} (wherein 0.90≦a≦1.8, 0≦b≦0.5, 0≦c≦0.05, and 0<α<2); LiₐNi_{1bc}Mn_{b}B_{c}O₂F_{α} (wherein 0.90≦a≦1.8, 0≦b≦0.5, 0≦c≦0.05, and 0<α<2); LiₐNi_{1bc}Mn_{b}B_{c}O₂ₐF₂ (wherein 0.90≦a≦1.8, 0≦b≦0.5, 0≦c≦0.05, and 0≦c≦2); LiₐNi_{b}E_{c}G_{d}O₂ (wherein 0.90≦a≦1.8, 0≦0.9, 0≦c≦0.5, and 0.001≦d≦0.1); LiₐNi_{b}Co_{c}Mn_{d}GeO₂ (wherein 0.90≦a≦1.8, 0≦0.9, 0≦c≦0.5, 0≦a≦0.5, and 0.001≦a≦0.1); LiₐNiG_{b}O₂ (wherein 0.90≦a≦1.8, and 0.001≦b≦0.1); LiₐCoG_{b}O₂(wherein 0.90≦a≦1.8, and 0.001≦b≦0.1); LiₐMnG_{b}O₂ (wherein 0.90≦a≦1.8, and 0.001≦b≦0.1); LiₐMn₂G_{b}O₄ (wherein 0.90≦a≦1.8, and 0.001≦b≦0.1); QO₂; QS₂; LiQS₂; V₂O₅; LiV₂O₅; LiIO₂; LiNiVO₄; Li_{(3f)}J₂(PO₄)₃(0≦f≦2); Li_{(3f)}Fe₂(PO₄)₃(0≦f≦2); and LiFePO₄.

In the above Chemical Formulae, A is Ni, Co, Mn or a combination thereof; B is Al, Ni, Co, Mn, Cr, Fe, Mg, Sr, V, rare earth elements or a combination thereof; D is O, F, S, P or a combination thereof; E is Co, Mn or a combination thereof; F is F, S, P or a combination thereof; G is Al, Cr, Mn, Fe, Mg, La, Ce, Sr, V or a combination thereof; Q is Ti, Mo, Mn or a combination thereof; I is Cr, V, Fe, Sc, Y or a combination thereof; and J is V, Cr, Mn, Co, Ni, Cu or a combination thereof.

The anode includes an anode active material capable of absorbing and releasing lithium ions, and as the anode active material, carbon materials such as crystalline carbon, amorphous carbon, a carbon composite and carbon fiber, a lithium metal, an alloy of lithium and another element, and the like may be used. For example, amorphous carbon includes hard carbon, cokes, mesocarbon microbead (MCMB) sintered at 1500° C. or less, mesophase pitchbased carbon fiber (MPCF), and the like. The crystalline carbon includes graphite-based materials, specifically natural graphite, graphitized cokes, graphitized MCMB, graphitized MPCF and the like. The carbon materials are preferably a material having an interplanar distance of 3.35-3.38 Å, and Lc (crystallite size) by X-ray diffraction of at least 20 nm. As other materials forming an alloy with lithium, aluminum, zinc, bismuth, cadmium, antimony, silicon, lead, tin, gallium or indium may be used.

The cathode or the anode may be prepared by dispersing an electrode active material, a binder and a conductive material, and if necessary, a thickener in a solvent to prepare an electrode slurry composition, and applying the slurry composition on an electrode current collector. As a cathode current collector, aluminum, an aluminum alloy or the like may be commonly used, and as an anode current collector, copper, a copper alloy or the like may be commonly used. The cathode current collector and the anode current collector may be in the form of foil or mesh.

The binder which is a material serving as formation of a paste of an active material, mutual adhesion of an active material, adhesion with a current collector, a buffer effect for expansion and contraction of an active material, and the like, includes for example, polyvinylidene fluoride (PVdF), a copolymer of polyhexafluoropropylene-polyvinylidene fluoride (PVdF/HFP), poly(vinyl acetate), polyvinyl alcohol, polyethylene oxide, polyvinyl pyrrolidone, alkylated polyethylene oxide, polyvinyl ether, poly(methylmethacrylate), poly(ethylacrylate), polytetrafluoroethylene, polyvinyl chloride, polyacrylonitrile, polyvinyl pyridine, styrene butadiene rubber, acrylonitrile butadiene rubber, and the like. The content of the binder is 0.1 to 30 wt %, preferably 1 to 10 wt %, relative to an electrode active material. If the content of the binder is too low, the adhesion between the electrode active material and the current collector will be insufficient, and if the content of the binder is too high, the adhesion will be better, but the content of the electrode active material will be reduced by the increased amount of the binder, and thus, it is disadvantageous to increase a battery capacity.

The conductive material which is used for imparting conductivity to an electrode, may be any material only if it does not cause chemical change, and is an electron conductive material, in a composed battery, and at least one selected from the group consisting of a graphite-based conductive material, a carbon black-based conductive material, a metal or metal compound-based conductive material may be used. An example of the graphite-based conductive material includes artificial graphite, natural graphite or the like, an example of the carbon black-based conductive material includes acetylene black, ketjen black, denka black, thermal black, channel black, or the like, and an example of the metal-based or metal compound-based conductive material includes a perovskite material such as tin, tin oxide, tin phosphate (SnPO₄), titanium oxide, potassium titanate, LaSrCoO₃ or LaSrMnO₃. However, the conductive material is not limited to those listed above.

The content of the conductive material is preferably 0.1 to 10 wt % relative to an electrode active material. If the content of the conductive material is less than 0.1 wt %, an electrochemical property is lowered, and if the content is above 10 wt %, energy density per weight is reduced.

The thickener is not particularly limited, only if it may serve to control the viscosity of active material slurry, but for example, carboxymethyl cellulose, hydroxymethyl cellulose, hydroxyethyl cellulose, hydroxypropyl cellulose or the like may be used.

As the solvent in which the electrode active material, the binder, the conductive material and the like are dispersed, a non-aqueous solvent or an aqueous solvent is used. As the non-aqueous solvent, N-methyl-2-pyrrolidone (NMP), dimethyl formamide, dimethyl acetamide, N,N-dimethylaminopropylamine, ethylene oxide, tetrahydrofurane or the like may be included.

The lithium secondary battery of the present invention may include a separator preventing a short circuit between a cathode and an anode, and providing lithium ion channels, and as the separator, a polyolefin-based polymer layer such as polypropylene, polyethylene, polyethylene/polypropylene, polyethylene/polypropylene/polyethylene, and polypropylene/polyethylene/polypropylene, or a multi-layer thereof, a microporous film, and woven and non-woven fabric may be used. Further, a film where a resin having excellent stability is coated on a porous polyolefin film may be used.

The lithium secondary battery may be formed in another shape such as a cylinder, a pouch and the like in addition to a square shape.

Hereinafter, the Examples and Comparative Examples of the present invention will be described. However, the following Examples are only one preferred exemplary embodiment, and the present invention is not limited thereto. Assuming that a lithium salt is all dissociated so that a lithium ion concentration becomes 1 mol (1 M), a base electrolyte may be formed by dissolving a corresponding amount of a lithium salt such as LiPF₆ in a basic solvent to a concentration of 1 mol (1 M).

### Preparation Example 1

### Synthesis of Diethylene Glycol Diacetate (Hereinafter, Referred to as ‘PHE 10’)

Diethylene glycol (70 g), triethylamine (192 mL) and acetic anhydride (137 mL) were added to dichloromethane (800 mL), and then stirred at a room temperature for 24 hours. After completion of the reaction, an organic layer was washed with an ammonium chloride aqueous solution, a sodium hydrogen carbonate aqueous solution and a sodium chloride aqueous solution. After removing moisture from the organic layer with magnesium sulfate, the magnesium sulfate was removed through filtration, and the solvent was removed by vacuum distillation. After adding dried calcium chloride, diethylene glycol diacetate (110 g) from which residual moisture and impurities were removed through vacuum distillation was obtained.

¹H NMR (CDCl₃, 500 MHz) δ 4.04 (t, 2H), 3.52 (t, 2H), 1.90 (s, 3H)

### Preparation Example 2

### Synthesis of Triethylene Glycol Diacetate (Hereinafter, Referred to as ‘PHE 11’)

Triethylene glycol (99 g), triethylamine (192 mL) and acetic anhydride (137 mL) were added to dichloromethane (800 mL), and then stirred at a room temperature for 24 hours. After completion of the reaction, an organic layer was washed with an ammonium chloride aqueous solution, a sodium hydrogen carbonate aqueous solution and a sodium chloride aqueous solution. After removing moisture from the organic layer with magnesium sulfate, the magnesium sulfate was removed through filtration, and the solvent was removed by vacuum distillation. After adding dried calcium chloride, triethylene glycol diacetate (130 g) from which residual moisture and impurities were removed through vacuum distillation was obtained.

¹H NMR (CDCl₃, 500 MHz) δ 3.97 (t, 2H), 3.46 (t, 2H), 3.42 (s, 2H), 1.83 (s, 3H)

### Preparation Example 3

### Synthesis of Ethylene Glycol Diacetate (Hereinafter, Referred to as ‘PHE 17’)

Ethylene glycol (41 g), triethylamine (192 mL) and acetic anhydride (137 mL) were added to dichloromethane (800 mL), and then stirred at a room temperature for 24 hours. After completion of the reaction, an organic layer was washed with an ammonium chloride aqueous solution, a sodium hydrogen carbonate aqueous solution and a sodium chloride aqueous solution. After removing moisture from the organic layer with magnesium sulfate, the magnesium sulfate was removed through filtration, and the solvent was removed by vacuum distillation. After adding dried calcium chloride, ethylene glycol diacetate (85 g) from which residual moisture and impurities were removed through vacuum distillation was obtained.

¹H NMR (CDCl₃, 500 MHz) δ 4.06 (t, 4H), 2.01 (s, 6H)

### Preparation Example 4

### Synthesis of Ethylene Glycol Bis(Methyl Carbonate) (Hereinafter, Referred to as ‘PHE 18’)

To a mixed solution of 1-methylimidazole (90 g) and ethylene glycol (31 g), methyl formate chloride (39 mL) was slowly added, and then stirred at 0° C. for 3 hours. Extraction was carried out using water and ethyl acetate, and an extracted organic layer was washed with a sodium hydroxide aqueous solution, and thereafter, magnesium sulfate was added for drying. Ethylene glycol bis(methyl carbonate) (80 g) from which moisture was removed through vacuum distillation was obtained.

¹H NMR (CDCl₃, 500 MHz) δ 4.15 (s, 4H), 3.51 (s, 6H)

### Preparation Example 5

### Synthesis of 1,2,3-Propanetriol Triacetate (Hereinafter, Referred to as ‘PHE 21’)

Glycerin (61 g), triethylamine (192 mL) and acetic anhydride (137 mL) were added to dichloromethane (800 mL), and then stirred at a room temperature for 24 hours. After completion of the reaction, an organic layer was washed with an ammonium chloride aqueous solution, a sodium hydrogen carbonate aqueous solution and a sodium chloride aqueous solution. After removing moisture from the organic layer with magnesium sulfate, the magnesium sulfate was removed through filtration, and the solvent was removed by vacuum distillation. After adding dried calcium chloride, 1,2m3-propanetriol triacetate (130 g) from which residual moisture and impurities were removed through vacuum distillation was obtained.

¹H NMR (CDCl₃, 500 MHz) δ 5.25 (tt, 1H), 4.30 (dd, 2H), 4.16 (dd, 2H), 2.10 (s, 3H), 2.09 (s, 6H)

### Preparation Example 6

### Synthesis of 1,4-Diacetoxybutane (Hereinafter, Referred to as ‘PHE23’)

1,4-butanediol (59 g), triethylamine (192 mL) and acetic anhydride (137 mL) were added to dichloromethane (800 mL), and then stirred at a room temperature for 24 hours. After completion of the reaction, an organic layer was washed with an ammonium chloride aqueous solution, a sodium hydrogen carbonate aqueous solution and a sodium chloride aqueous solution. After removing moisture from the organic layer with magnesium sulfate, the magnesium sulfate was removed through filtration, and the solvent was removed by vacuum distillation. After adding dried calcium chloride, 1,4-diacetoxybutane (100 g) from which residual moisture and impurities were removed through vacuum distillation was obtained.

¹H NMR (CDCl₃ 500 MHz) δ 4.09 (t, 4H), 2.05 (s, 6H), 1.71 (m, 4H)

### Examples 1-9 and Comparative Examples 1-3

Electrolytes were prepared by further adding the components described in following Table 1 to a base electrolyte (IM LiPF₆, EC/EMC=3:7) which is a solution having LiPF₆ dissolved in a mixed solvent of ethylene carbonate (EC) and ethylmethyl carbonate (EMC) at a volume ratio of 3:7 to become a 1.0 M solution.

A battery to which the non-aqueous electrolyte is applied was prepared as follows:

LiNiCoMnO₂ and LiMn₂O₄ were mixed at a weight ratio of 1:1 as a cathode active material, polyvinylidene fluoride (PVdF) as a binder and carbon as a conductive material were mixed therewith at a weight ratio of 92:4:4, and then dispersion in N-methyl-2-pyrrolidone was carried out to prepare cathode slurry. This slurry was coated on aluminum foil having a thickness of 20 μm, which was then dried and rolled to prepare a cathode. Artificial graphite as an anode active material, styrene butadiene rubber as a binder and carboxymethyl cellulose as a thickener were mixed at a weight ratio of 96:2:2, and then dispersed in water to prepare anode active material slurry. This slurry was coated on copper foil having a thickness of 15 μm, which was then dried and rolled to prepare an anode.

A film separator made of polyethylene (PE) having a thickness of 25 μm was stacked between the prepared electrodes to form a cell using a pouch having a size of 8 mm thick×270 mm width×185 mm length, and the non-aqueous electrolyte was injected to prepare a 25 Ah lithium secondary battery for EV.

Performance of the thus prepared 25 Ah battery for EV was evaluated as follows. Evaluation items are the following:

Evaluation Items

1. Capacity recovery rate at 60° C. after 30 days (storage efficiency at a high temperature): A battery was charged to 4.4V with 12.5A CCCV at room temperature for 3 hours, left at 60° C. for 30 days, and discharged to 2.7V with CC with 25A current, and thereafter, available capacity (%) relative to initial capacity was measured.

2. Thickness increase rate at 60° C. after 30 days: A battery was charged to 4.4V, with 12.5A CCCV at room temperature for 3 hours, and thereafter, a thickness of the battery was indicated as A, and a thickness of the battery left at 60° C. by using a closed thermostatic device for 30 days under normal pressure exposed to atmosphere was indicated as B, then a thickness increase rate was calculated by following Equation 1:

(BA)/A*100(%) [Equation 1]

3. Room temperature life: A battery was charged to 4.4V, with 25A CCCV at a room temperature for 3 hours, and then discharge was repeated 300 times to 2.7V with 2.7V, 25A current. Herein, the discharge capacity of the 1^{st} time was indicated as C, and the discharge capacity of the 300^{th} time was divided by the discharge capacity of the 1^{st} time to calculate a capacity retention rate over a lifetime.

TABLE 1

| | | After 30 days at | | |
|---|---|---|---|---|
| | | 60° C. | | Capacity |
| | | Capacity | Thickness | retention |
| | | recovery | increase | Rate over |
| | Electrolyte composition | rate | rate | a lifetime |
| Ex. 1 | Base electrolyte + PHE10 10 wt % | 88% | 5% | 77% |
| Ex. 2 | Base electrolyte + PHE11 10 wt % | 84% | 15% | 78% |
| Ex. 3 | Base electrolyte + PHE17 15 wt % | 82% | 11% | 83% |
| Ex. 4 | Base electrolyte + PHE18 10 wt % | 83% | 9% | 81% |
| Ex. 5 | Base electrolyte + PHE21 10 wt % | 90% | 6% | 74% |
| Ex. 6 | Base electrolyte + PHE23 10 wt % | 82% | 9% | 74% |
| Ex. 7 | Base electrolyte + PHE10 10 wt % + | 88% | 3% | 88% |
| | LiBOB 1 wt % | | | |
| Ex. 8 | Base electrolyte + PHE10 10 wt % + | 92% | 1% | 90% |
| | VC 1 wt % | | | |
| Ex. 9 | Base electrolyte + PHE10 10 wt % + | 93% | 1% | 91% |
| | VC 1 wt % + PS 1 wt % | | | |
| Comparative | Base electrolyte | 37% | 30% | 20% |
| Ex. 1 | | | | |
| Comparative | Base electrolyte + | 33% | 45% | 12% |
| Ex. 2 | CH₃CH₂O(CH₂)₂OCOCH₃ 10 wt % | | | |
| Comparative | Base electrolyte + | 24% | 56% | 8% |
| Ex. 3 | CH₃CH₂O(CH₂)₂COOCH₂CH₃10 wt % | | | |

Base electrolyte: 1M LiPF₆, EC/EMC = 3:7
LiBOB: Lithiumbis(Oxalato)Borate
VC: vinylene carbonate
PS: 1,3-propane sultone

As shown in Table 1, it is recognized that the lithium secondary battery including the electrolyte for a lithium secondary battery according to the present invention showed a storage efficiency at a high temperature of 80% or more. Further, it was confirmed that the lithium secondary battery employing the lithium secondary battery electrolyte including the ester compound of the Chemical Formula 1 according to the present invention had a very low battery thickness increase rate of 1-15% when allowed to stand at a high temperature over a long period of time, and a capacity retention rate over a lifetime was 70% or more which is excellent (Examples 1 to 9). However, Comparative Examples 1 to 3 showed storage efficiency at high temperature of 40% or less, and at the same time, a very high battery thickness increase rate of 30 to 56% when allowed to stand at a high temperature over a long period of time, and also, had a very low capacity retention rate over a lifetime of 20% in Comparative Example 1, 12% in Comparative Example 2, and 8% in Comparative Example 3.

It is expected that such results are due to a structural property of the compound added to a base electrolyte. That is, the ester compound represented by the Chemical Formula 1 added to the electrolyte for a secondary battery of the present invention has a structure having independently of each other, two or more ester groups or carbonate groups in the compound, and as being recognizable from the fact that the compound of the Chemical Formula 1 has higher storage stability at a high temperature and capacity retention rate over a lifetime than the compounds of Comparative Examples 2 and 3 having one ester group in the compounds, such property is attributed to the structural property of the compound added to the base electrolyte.

More specifically, the compound of Comparative Example 2 which is CH₃CH₂O(CH₂)₂OCOCH₃ has a structure having one ester group in the compound, and also the compound of Comparative Example 3 which is CH₃CH₂O(CH₂)₂COOCH₂CH₃ has a structure having one ester group in the compound. In case of Comparative Examples 2 and 3, the batteries have rather higher storage stability at a high temperature and capacity retention rate over a lifetime, and a lower thickness increase rate when allowed to stand at a high temperature over a long period of time than the lithium secondary battery of Comparative Example 1 including the base electrolyte, however, when compared with the ester compound of the Chemical Formula 1 of the present invention having independently of each other two or more ester groups or carbonate groups in the compound, have significantly reduced properties.

Particularly, PHE21 of the present invention which has a structure having three ester groups in the compound, has high storage stability at a high temperature and a very high capacity retention rate over a lifetime.

That is, the ester compound of the present invention has two or more ester groups or carbonate groups in the compound, thereby having high storage stability at a high temperature, and capacity retention rate over a lifetime, and when allowed to stand at a high temperature over a long period of time, has a low thickness increase rate, and thus, the efficiency and stability of the lithium secondary battery employing the ester compound of the present invention in an electrolyte may be increased.

Further, a combination of the ester compound of the present invention, LiBOB of an oxlatoborate-based compound as a life improving additive, and vinylene carbonate of a vinylidene carbonate-based compound represented particularly high storage stability at a high temperature, and capacity retention rate over a lifetime, and as seen from the fact that a combination of the ester compound of the present invention, vinylene carbonate (VC) and PS has higher electric properties, the lithium secondary battery employing a combination of the ester compound of the present invention, vinylene carbonate and PS has very high storage stability at a high temperature and efficiency.

Further, it is expected that a boiling point of a solvent is correlates to a storage property at a high temperature in a high voltage battery, and it is also expected that as the boiling point is higher, electrolyte decomposition tends to be reduced.

The boiling points of the compounds used in Examples and Comparative Examples are shown in following Table 2:

TABLE 2

| | | | Boiling |
|---|---|---|---|
| Compound | Boiling point | Compound | point |
| PHE 10 | 206° C. | EMC | 107° C. |
| PHE 11 | 289° C. | DEC | 126° C. |
| PHE 17 | 187° C. | EC | 244° C. |
| PHE 18 | 215° C. | CH₃CH₂O(CH₂)₂OCOCH₃ | 156° C. |
| PHE 21 | 258° C. | CH₃CH₂O(CH₂)₂COOCH₂CH₃ | 166° C. |
| PHE 23 | 220° C. | | |

As seen from Table 2, the compounds of Comparative Examples 2 and 3 have higher boiling points than the carbonate-based compound (EMC) of the base electrolyte of Comparative Example 1, and thus, the batteries of Comparative Examples 2 and 3 will have higher storage stability at a high temperature and capacity retention rate over a lifetime than the lithium secondary battery of Comparative Example 1. However, the compounds of Comparative Examples 2 and 3 have lower boiling points, and lower storage stability at a high temperature and capacity retention rate over a lifetime than the ester compound of the present invention having two or more ester groups or carbonate groups in the compound.

Accordingly, the lithium secondary battery of the Comparative Examples has low storage stability at a high temperature, thereby having a much higher thickness increase rate when allowed to stand at a high temperature than the lithium secondary battery of the present invention.

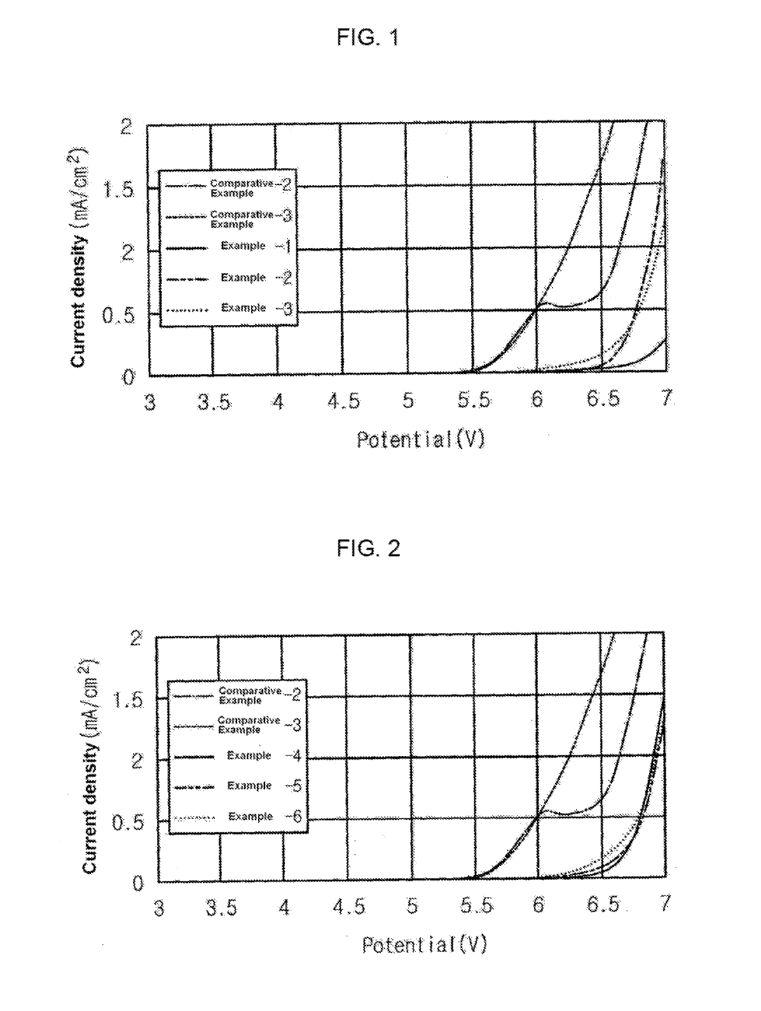

Further, in order to measure oxidative decomposition voltage of the batteries of Examples 1 to 6, and Comparative Examples 2 and 3, LSV (Linear Sweep Voltametry) was measured using a Pt electrode as a working electrode, and a Li metal as a counter electrode and a reference electrode, and the results are shown in FIG. 1.

As shown in FIG. 1, it is confirmed that the lithium secondary battery employing the electrolyte for a secondary battery including the ester compound represented by the Chemical Formula 1 of the present invention has a higher electrolyte oxidation potential than the lithium secondary battery employing the compound having a different structure from the Chemical Formula 1 of the present invention, that is, the compound having one ester group in the compound as the electrolyte for a lithium secondary battery, so that decomposition at high voltage is less, and it can be seen from such results that the lithium secondary battery of the present invention has high stability.

Further, regarding the storage property at a high temperature which is vulnerability of a high voltage battery, the compound of the present invention having two or more ester groups in the compound has a higher boiling point, and also a higher storage property at a high temperature than DEC or EMC.

As described above, though the Examples of the present invention have been described in detail, a person skilled in the art may make various variations of the present invention without departing from the spirit and the scope of the present invention, as defined in the claims which follow. Accordingly, any modification of the Examples of the present invention in the future may not depart from the technique of the present invention.

1. An electrolyte for a secondary battery comprising:
a lithium salt;
a non-aqueous organic solvent; and
an ester compound represented by following Chemical Formula 1: 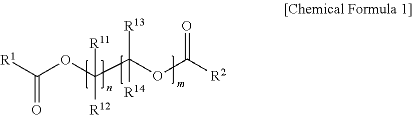
wherein
R¹ and R² are independently of each other a (C1-C5) alkyl group or a (C1-C5) alkoxy group;
R¹¹ to R¹⁴ are independently of one another hydrogen, a (C1-C5) alkyl group, a (C1-C5) alkoxy group or 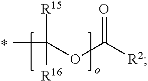
R¹⁵ and R¹⁶ are independently of each other hydrogen, a (C1-C5) alkyl group or a (C1-C5) alkoxy group;
o is an integer of 0 to 3;
m is an integer of 0 to 6;
n is an integer of 0 to 6; and
m and n are not 0 at the same time.

2. The electrolyte for a secondary battery of claim 1, wherein in the Chemical Formula 1, R¹¹ to R¹⁴ are independently of one another hydrogen or 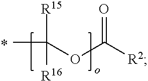
R¹⁵ and R¹⁶ are independently of each other hydrogen, a (C1-C5) alkyl group or a (C1-C5) alkoxy group; and o is an integer of 0 to 3.

3. The electrolyte for a secondary battery of claim 2, wherein in the Chemical Formula 1, R¹ and R² are independently of each other methyl, ethyl, propyl, isopropyl, n-butyl, tert-butyl, methoxy, ethoxy, propoxy, n-butoxy or tert-butoxy.

4. The electrolyte for a secondary battery of claim 1, wherein the Chemical Formula 1 is selected from the group consisting of following structures:

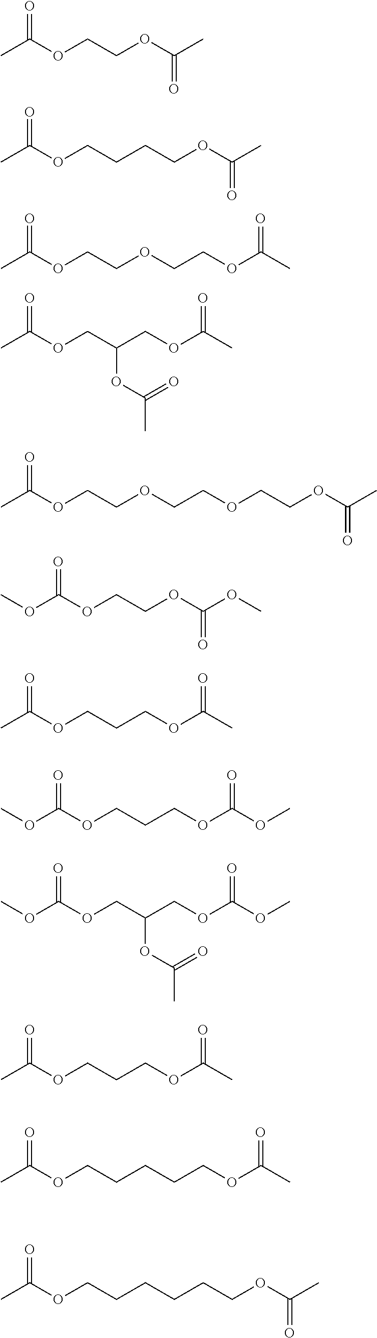

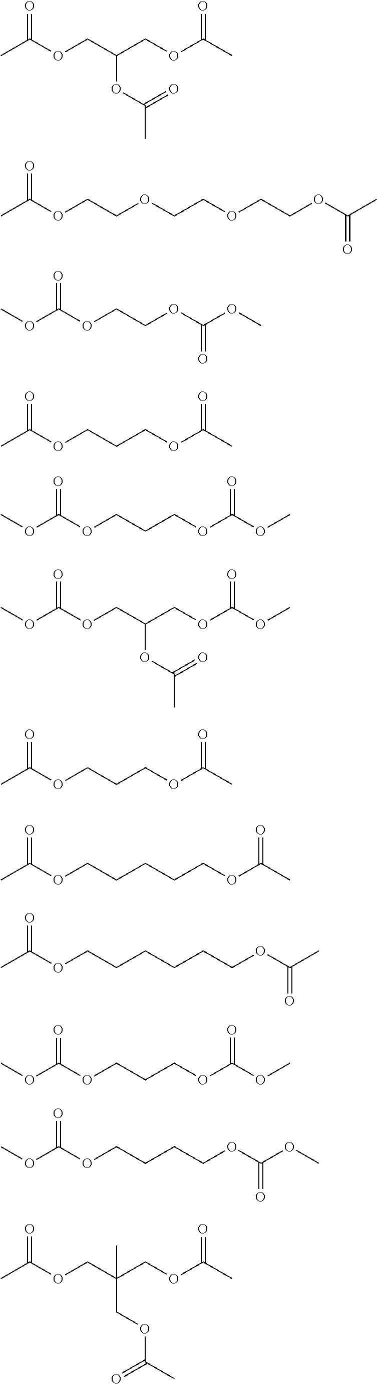

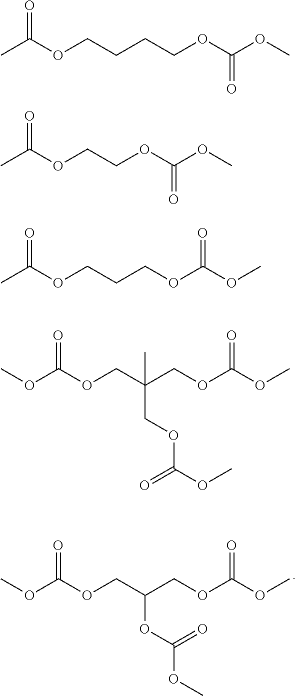

5. The electrolyte for a secondary battery of claim 1, wherein the ester compound is contained in 1 to 20 wt % relative to a total weight of the electrolyte.

6. The electrolyte for a secondary battery of claim 1, further comprising one or two or more additives selected from the group consisting of an oxalatoborate-based compound, a fluorine-substituted carbonate-based compound, a vinylidene carbonate-based compound, and a sulfinyl group-containing compound.

7. The electrolyte for a secondary battery of claim 6, further comprising an additive selected from the group consisting of lithium difluorooxalatoborate (LiFOB), lithium bisoxalatoborate (LiB(C₂O₄)₂, LiBOB), fluoroethylenecarbonate (FEC), vinylene carbonate (VC), vinylethylene carbonate (VEC), divinyl sulfone, ethylene sulfite, propylene sulfite, diallyl sulfonate, ethane sultone, propane sultone (PS), butane sultone, ethene sultone, butene sultone and propene sultone (PS).

8. The electrolyte for a secondary battery of claim 6, wherein the additive is contained in 0.1 to 5.0 wt % relative to a total weight of the electrolyte.

9. The electrolyte for a secondary battery of claim 1, wherein the non-aqueous organic solvent is selected from the group consisting of a cyclic carbonate-based solvent, a linear carbonate-based solvent, and a mixed solvent thereof.

10. The electrolyte for a secondary battery of claim 9, wherein the cyclic carbonate is selected from the group consisting of ethylene carbonate, propylene carbonate, butylene carbonate, vinylene carbonate, vinylethylene carbonate, fluoroethylene carbonate and a mixture thereof, and the linear carbonate is selected from the group consisting of dimethyl carbonate, diethyl carbonate, dipropyl carbonate, ethylmethyl carbonate, methylpropyl carbonate, methylisopropyl carbonate, ethylpropyl carbonate and a mixture thereof.

11. The electrolyte for a secondary battery of claim 9, wherein the non-aqueous organic solvent has a mixed volume ratio between the linear carbonate-based solvent: the cyclic carbonate-based solvent of 1:1 to 9:1.

12. The electrolyte for a secondary battery of claim 1, wherein the lithium salt is one or two or more selected from the group consisting of LiPF₆, LiBF₄, LiClO₄, LiSbF₆, LiAsF₆, LiN(SO₂C₂F₅)₂, LiN(CF₃SO₂)₂, LiN(SO₃C₂F₅)₂, LiCF₃SO₃, LiC₄F₉SO₃, LiC₆H₅SO₃, LiSCN, LiAlO₂, LiAlCl₄, LiN(CₓF₂ₓ₊₁SO₂)(C_{y}F_{2y+1}SO₂) (wherein x and y are a natural number), LiCl, LiI, and LiB(C₂O₄)₂.

13. The electrolyte for a secondary battery of claim 1, wherein the lithium salt is present at a concentration of 0.1 to 2.0 M.

14. A lithium secondary battery comprising the electrolyte for a secondary battery of claim 1.
